(19) United States
(12) Patent Application Publication
(10) Pub. No.: US 2023/0343338 A1
(43) Pub. Date: Oct. 26, 2023

(54) METHOD FOR AUTOMATIC LIP READING BY MEANS OF A FUNCTIONAL COMPONENT AND FOR PROVIDING SAID FUNCTIONAL COMPONENT

(71) Applicant: Clinomic Medical GmbH, Aachen (DE)

(72) Inventors: Arne PEINE, Aachen (DE); Lukas MARTIN, Aachen (DE)

(21) Appl. No.: 18/005,640

(22) PCT Filed: Jul. 7, 2021
(86) PCT No.: PCT/EP2021/068915

§ 371 Date: Jan. 16, 2023

(30) Foreign Application Priority Data
Jul. 17, 2020 (DE) 10 2020 118 967.2
Jul. 23, 2020 (EP) 20187321.3

(51) Int. Cl. G10L 15/25; G06V 40/16; G06V 10/774; G10L 13/02; G10L 25/24; G10L 15/06; G06V 10/82; G10L 15/18; G06V 40/20

(52) U.S. Cl. CPC G10L 15/25; G06V 40/171; G06V 10/774; G10L 13/02; G10L 25/24; G10L 15/063; G06V 10/82; G10L 15/1815; G06V 40/20

(57) ABSTRACT

A method for providing at least one functional component for an automatic lip reading process. The method includes providing at least one recording comprising audio information about speech of a speaker and image information about a mouth movement of the speaker, and training an image evaluation component, wherein the image information is used for an input of the image evaluation component and the audio information is used as a learning specification for an output of the image evaluation component in order to train the image evaluation component to artificially generate the speech during a silent mouth movement.

### TECHNICAL FIELD

The invention relates to a method for providing at least one functional component for automatic lip reading, and to a method for automatic lip reading by means of the functional component. Furthermore, the invention relates to a system and to a computer program.

### PRIOR ART

The prior art discloses methods for automatic lip reading in which the speech is recognized directly from a video recording of a mouth movement by means of a neural network. Such methods are thus embodied in a single stage. Furthermore, it is also known to carry out speech recognition, likewise in a single stage, on the basis of audio recordings.

One method for automatic lip reading is known e.g. from U.S. Pat. No. 8,442,820 B2. Further conventional methods for lip reading are known, inter alia, from “Assael et al., LipNet: End-to-End Sentence-level Lipreading, arXiv:1611.01599, 2016” and “J. S. Chung, A. Senior, O. Vinyals, and A. Zisserman, “Lip reading sentences in the wild”, in 2017 IEEE Conference on Computer Vision and Pattern Recognition (CVPR). IEEE, 2017, pp. 3444-3453.

### Problem Addressed by the Invention

The present invention addresses the problem of providing the prior art with an addition, improvement or alternative.

### Solution and Advantages of the Invention

The above problem is solved by means of the patent claims. Further features of the invention are evident from the description and the drawings. In this case, features described in association with the method according to the invention are also applicable in association with the further method according to the invention, the system according to the invention and the computer program according to the invention, and vice versa in each case.

According to a first aspect of the invention, the problem addressed is solved by a method for providing at least one functional component, in particular for automatic lip reading. In other words, the method can serve to provide the at least one functional component in each case for use during automatic lip reading, preferably in such a way that the respective functional component makes available at least one portion of the functions in order to enable the automatic lip reading.

In this case, provision is made for the following steps to be carried out, preferably successively in the order indicated, wherein the steps can optionally also be carried out repeatedly:
providing at least one (advantageously digital) recording which comprises at least one item of audio information about speech of a (human) speaker and image information about a mouth movement of the speaker,
carrying out training of an image evaluation means, preferably in order to provide the trained image evaluation means as the (or one of the) functional component(s), wherein the image information can be used for an input of the image evaluation means and the audio information can be used as a learning specification for an output of the image evaluation means in order preferably to train the image evaluation means to artificially generate the speech during a silent mouth movement.

In this way, the image evaluation means can advantageously be provided as a functional component and be trained to determine the audio information from the image information. In other words, the image evaluation means can be trained to generate the associated speech sounds from a visual recording of the mouth movement. This can also afford the advantage, if appropriate, that the image evaluation means as a stage of a multi-stage method is embodied for supporting lip reading with high reliability. In contrast to conventional methods, in this case firstly the audio information is generated for lip reading purposes. Furthermore, the training can be geared specifically toward training the image evaluation means to artificially generate the speech during a silent mouth movement, i.e. without the use of spoken speech as input. This then distinguishes the method according to the invention from conventional speech recognition methods, in which the mouth movement is used merely as assistance in addition to the spoken speech as input.

A recording is understood to mean a digital recording, in particular, which can have the audio information as acoustic information (such as an audio file) and the image information as visual information (without audio, i.e. e.g. an image sequence).

The image information can be embodied as information about moving images, i.e. a video. In this case, the image information can be soundless, i.e. comprise no audio information. By contrast, the audio information can comprise (exclusively) sound and thus acoustic information about the speech and hence only the spoken speech, i.e. comprise no image information. By way of example, the recording can be determined by way of a conventional video and simultaneous sound recording of the speaker's face, the image and sound information then being separated therefrom in order to obtain the image and audio information. For the training the speaker can use spoken speech which is then automatically accompanied by a mouth movement of the speaker, which can at least almost correspond to a soundless mouth movement without spoken speech.

The training can also be referred to as learning since, by way of the training and in particular by means of machine learning, the image evaluation means is trained to output for the predefined image information as input the predefined audio information (predefined as learning specification) as output. This makes it possible to apply the trained (or learned) image evaluation means even with such image information as input which deviates from the image information specifically used during training. In this case, said image information also need not be part of a recording which already contains the associated audio information. The image information about a silent mouth movement of the speaker can then also be used as input, in the case of which the speech of the speaker is merely present as silent speech. The output of the trained image evaluation means can then be used as audio information, which can be regarded as an artificial product of the speech of the image information.

In the context of the invention, a silent mouth movement can always be understood to mean such a mouth movement which serves exclusively for outputting silent speech—i.e. speech that is substantially silent and visually perceptible only by way of the mouth movement. In this case, the silent mouth movement is used by the speaker without (clearly perceptible) acoustic spoken speech. By contrast, during training, the recording can at least partly comprise the image and audio information about visually and simultaneously also acoustically perceptible speech, such that in this case the mouth movement of both visually and acoustically perceptible speech is used. A mouth movement can be understood to mean a movement of the face, lips and/or tongue.

The training described has the advantage that the image evaluation means is trained (i.e. by learning) to estimate the acoustic information from the visual recording of the mouth movement and optionally without available acoustic information about the speech. In contrast to conventional methods, it is then not necessary for acoustic information about the speech to be required for speech recognition. Known methods here often use the mouth movement only for improving audio-based speech recognition. By contrast, according to the present invention, acoustic information about the speech, i.e. the spoken speech, can optionally be completely dispensed with, and the acoustic information about the image evaluation means can instead be estimated on the basis of the mouth movement (i.e. the image information). In the case where the method is implemented in stages, this also makes it possible to use conventional speech recognition modules if the acoustic information is not available or present. By way of example, the use of the functional component provided is advantageous for patients at a critical care unit who may move their lips, but are not able to speak owing to their medical treatment.

The image evaluation means can also be regarded as a functional module which is modular and thus flexibly suitable for different speech recognition methods and/or lip reading methods. In this regard, it is possible for the output of the image evaluation means to be used for a conventional speech recognition module such as is known e.g. from “Povey et al., The Kaldi Speech Recognition Toolkit, 2011, IEEE Signal Processing Society”. In this way, the speech can be provided e.g. in the form of text. Even further uses are conceivable, such as e.g. a speech synthesis from the output of the image evaluation means, which can then be output optionally acoustically via a loudspeaker of a system according to the invention.

Furthermore, applications of automatic lip reading can be gathered from the publication “L. Woodhouse, L. Hickson, and B. Dodd, ‘Review of visual speech perception by hearing and hearing-impaired people: clinical implications’, International Journal of Language & Communication Disorders, vol. 44, No. 3, pp. 253-270, 2009”. Particularly in the field of patient treatment e.g. at a critical care unit, medical professionals can benefit from automatic (i.e. machine-based) lip reading. If the acoustic speech of the patients is restricted, the method according to the invention can be used to nevertheless enable communication with the patient without other aids (such as handwriting).

### Advantageous Embodiments of the Invention

In a further possibility, provision can be made for the training to be effected in accordance with machine learning, wherein preferably the recording is used for providing training data for the training, and preferably the learning specification is embodied as ground truth of the training data. By way of example, the image information can be used as input, and the audio information as the ground truth. In this case, it is conceivable for the image evaluation means to be embodied as a neural network. A weighting of neurons of the neural network can accordingly be trained during the training. The result of the training is provided e.g. in the form of information about said weighting, such as a classifier, for a subsequent application.

Furthermore, in the context of the invention, provision can be made for the audio information to be used as the learning specification by virtue of speech features being determined from a transformation of the audio information, wherein the speech features can be embodied as MFCC, such that preferably the image evaluation means is trained for use as an MFCC estimator. MFCC here stands for “Mel Frequency Cepstral Coefficients”, which are often used in the field of automatic speech recognition. The MFCC are calculated e.g. by means of at least one of the following steps:
carrying out windowing of the audio information,
carrying out a frequency analysis, in particular a Fourier transformation, of the windowed audio information,
generating an absolute value spectrum from the result of the frequency analysis,
carrying out a logarithmization of the absolute value spectrum,
carrying out a reduction of the number of frequency bands of the logarithmized absolute value spectrum,
carrying out a discrete cosine transformation or a principal component analysis of the result of the reduction.

It can be possible for the image evaluation means to be trained or embodied as a model for estimating the MFCC from the image information. Afterward, a further model can be trained, which is dependent (in particular exclusively) on the sounds of the audio information in order to recognize the speech (audio-based speech recognition). In this case, the further model can be a speech evaluation means which produces a text as output from the audio information as input, wherein the text can reproduce the contents of the speech. It can be possible that, for the speech evaluation means, too, the audio information is firstly transformed into MFCC.

Moreover, in the context of the invention, it is conceivable for the recording additionally to comprise speech information about the speech, and for the following step to be carried out:
carrying out further training of a speech evaluation means for speech recognition, wherein the audio information and/or the output of the trained image evaluation means are/is used for an input of the speech evaluation means and the speech information is used as a learning specification for an output of the speech evaluation means.

The learning specification, in the sense of a predefined result or ground truth for machine learning, can comprise reference information as to what specific output is desired given an associated input. In this case, the audio information can form the learning specification or the ground truth for the image evaluation means, and/or speech information can form the learning specification or the ground truth for a speech evaluation means.

The training can be effected as supervised learning, for example, in which the learning specification forms a target output, i.e. the value which the image evaluation means or respectively the speech evaluation means is ideally intended to output. Moreover, it is conceivable to use reinforced learning as a method for the training, and to define the reward function on the basis of the learning specification. Further training methods are likewise conceivable in which the learning specification is understood as a specification of what output is ideally desired. The training can be effected in an automated manner, in principle, as soon as the training data have been provided. The possibilities for training the image and/or speech evaluation means are known in principle.

The selection and number of the training data for the training can be implemented depending on the desired reliability and accuracy of the automatic lip reading. Advantageously, therefore, according to the invention, what may be claimed is not a particular accuracy or the result to be achieved for the lip reading, but rather just the methodical procedure of the training and the application.

According to a further aspect of the invention, the problem addressed is solved by a method for automatic lip reading in the case of a patient, wherein the following steps can be carried out, preferably successively in the order indicated, wherein the steps can also be carried out repeatedly:
providing at least one item of image information about a silent mouth movement of the patient, preferably by way of speech of the patient that is recognizable visually on the basis of the mouth movement and is not acoustic, preferably in the case where the patient is prevented from speaking e.g. owing to a medical treatment, wherein the image information is determined e.g. by means of a camera recording of the mouth movement,
carrying out an application of an (in particular trained) image evaluation means with the image information for or as an input of the image evaluation means in order to use an output of the image evaluation means as audio information.

Furthermore, the following step can be carried out, preferably after carrying out the application of the image evaluation means:
carrying out an application of a speech evaluation means for (in particular acoustic) speech recognition with the audio information (i.e. the output of the image evaluation means) for or as an input of the speech evaluation means in order to use an output of the speech evaluation means as speech information about the mouth movement.

This can afford the advantage, in particular, that it is possible to use for the lip reading such speech recognition which generates the speech information directly from the audio information rather than directly from the image information. For speech evaluation means for such speech recognition, a large number of conventional solutions are known which can be adapted by the image evaluation means for the automatic lip reading. In this case, as is normally conventional practice in the case of speech recognition algorithms, the speech information can comprise the speech from the audio information in text form. In this case, however, the speech—acoustically in the sense of spoken speech—that is necessary for the speech recognition only becomes available as a result of the output of the image evaluation means, and is thus artificially generated from the silent mouth movement.

A further advantage can be afforded in the context of the invention if the image evaluation means and/or the speech evaluation means are/is configured as, in particular different, (artificial) neural networks, and/or if the image evaluation means and the speech evaluation means are applied sequentially for the automatic lip reading. The use of neural networks affords a possibility of training the image evaluation means on the basis of the training data which are appropriate for the desired results. A flexible adaptation to desired fields of application is thus possible. By virtue of the sequential application, it is furthermore possible to rely on a conventional speech evaluation means and/or to adapt the speech evaluation means separately from the image evaluation means by way of training. The image evaluation means is embodied e.g. as a convolutional neural network (CNN) and/or a recurrent neural network (RNN).

In the context of the invention, it is furthermore conceivable for the speech evaluation means to be configured as a speech recognition algorithm in order to generate the speech information from the audio information in the form of acoustic information artificially generated by the image evaluation means. Such algorithms are known e.g. from “Ernst Gunter Schukat-Talamazzini: Automatische Spracherkennung. Grundlagen, statistische Modelle and effiziente Algorithmen [Automatic speech recognition. Principles, statistical models and efficient algorithms], Vieweg, Baunschweig/Wiesbaden 1995, ISBN 3-528-05492-1”.

Furthermore, it is conceivable for the method to be embodied as an at least two-stage method for speech recognition, in particular of silent speech that is visually perceptible on the basis of the silent mouth movement. In this case, sequentially firstly the audio information can be generated by the image evaluation means in a first stage and subsequently the speech information can be generated by the speech evaluation means on the basis of the generated audio information in a second stage. The two-stage nature can be seen in particular in the fact that firstly the image evaluation means is used and it is only subsequently, i.e. sequentially, that the output of the image evaluation means is used as input for the speech evaluation means. In other words, the image evaluation means and speech evaluation means are concatenated with one another. In contrast to conventional approaches, the analysis of the lip movement is thus not used in parallel with the audio-based speech recognition. The audio-based speech recognition by the speech evaluation means can however be dependent on the result of the image-based lip recognition of the image evaluation means.

Preferably, in the context of the invention, provision can be made for the image evaluation means to have at least one convolutional layer which directly processes the input of the image evaluation means. Accordingly, the input can be directly convolved by the convolutional layer. By way of example, a different kind of processing such as principal component analysis of the input before the convolution is dispensed with.

Furthermore, provision can be made for the image evaluation means to have at least one GRU unit in order to generate, in particular directly, the output of the image evaluation means. Such “Gated Recurrent” units (GRU for short) are described e.g. in “Xu, Kai & Li, Dawei & Cassimatis, Nick & Wang, Xiaolong, (2018), ‘LCANet: End-to-End Lipreading with Cascaded Attention-CTC’, arXiV:1803.04988v1”. One possible embodiment of the image evaluation means is the so-called vanilla encoder. The image evaluation means can furthermore be configured as a “3D-Conv” encoder, which additionally uses three-dimensional convolutions. These embodiments are likewise described, inter alia, in the aforementioned publication.

Advantageously, in the context of the invention, provision can be made for the image evaluation means to have at least two or at least four convolutional layers. Moreover, it is possible for the image evaluation means to have a maximum of 2 or a maximum of 4 or a maximum of 10 convolutional layers. This makes it possible to ensure that the method according to the invention can be carried out even on hardware with limited computing power.

A further advantage can be afforded in the context of the invention if a number of successively connected convolutional layers of the image evaluation means is provided in the range of 2 to 10, preferably 4 to 6. A sufficient accuracy of the lip reading and at the same time a limitation of the necessary computing power are thus possible.

Provision can furthermore be made for the speech information to be embodied as semantic and/or content-related information about the speech spoken silently by means of the mouth movement of the patient. By way of example, this involves a text corresponding to the content of the speech. This can involve the same content which the same mouth movement would have in the case of spoken speech.

Furthermore, it can be provided that in addition to the mouth movement, the image information also comprises a visual recording of the facial gestures of the patient preferably in order that, on the basis of the facial gestures, too, the image evaluation means determines the audio information as information about the silent speech of the patient. The reliability of the lip reading can thus be improved further. In this case, the facial gestures can represent information that is specific to the speech.

Furthermore, it is conceivable for the image evaluation means and/or the speech evaluation means to be provided in each case as functional components by way of a method according to the invention (for providing at least one functional component).

According to a further aspect of the invention, the problem addressed is solved by a system comprising a processing device for carrying out at least the steps of an application of an image evaluation means and/or an application of a speech evaluation means of a method according to the invention for automatic lip reading in the case of a patient. The system according to the invention thus entails the same advantages as those described with reference to the methods according to the invention. Optionally, provision can be made for provision to be made of an image recording device for providing the image information. The image recording device is configured as a camera, for example, in order to carry out a video recording of a mouth movement of the patient. A further advantage in the context of the invention is achievable if provision is made of an output device for acoustically and/or visually outputting the speech information, e.g. via a loudspeaker of the system according to the invention. For output purposes, e.g. a speech synthesis of the speech information can be carried out.

According to a further aspect of the invention, the problem addressed is solved by a computer program, in particular a computer program product, comprising instructions which, when the computer program is executed by a processing device, cause the latter to carry out at least the steps of an application of an image evaluation means and/or of a speech evaluation means of a method according to the invention for automatic lip reading in the case of a patient. The computer program according to the invention thus entails the same advantages as those described with reference to the methods according to the invention. The computer program can be stored e.g. in a nonvolatile data memory of the system according to the invention in order to be read out therefrom for execution by the processing device.

The processing device can be configured as an electronic component of the system according to the invention. Furthermore, the processing device can have at least or exactly one processor, in particular microcontroller and/or digital signal processor and/or graphics processor. Furthermore, the processing device can be configured as a computer. The processing device can be embodied to execute the instructions of a computer program according to the invention in parallel. Specifically, e.g. the application of an image evaluation means and of a speech evaluation means can be executed in parallel by the processing device as parallelizable tasks.

### EXEMPLARY EMBODIMENTS

The invention will be explained in greater detail on the basis of exemplary embodiments in the drawings, in which, schematically in each case:

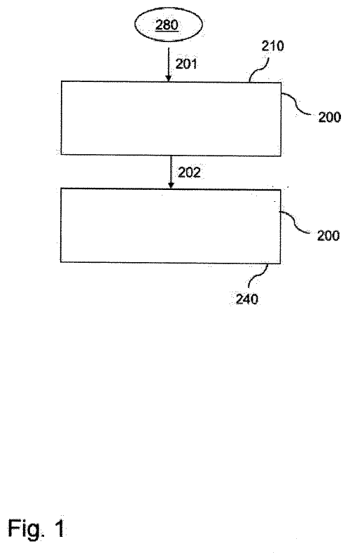

FIG. 1 shows method steps of a method according to the invention, an application of functional components being shown,

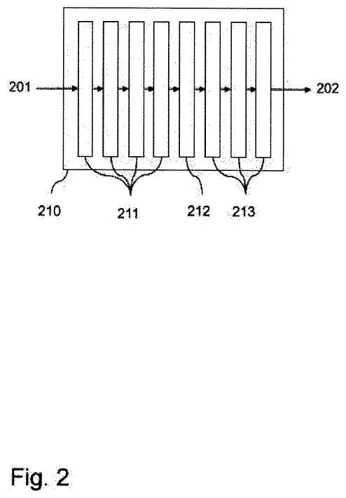

FIG. 2 shows one exemplary set-up of an image evaluation means,

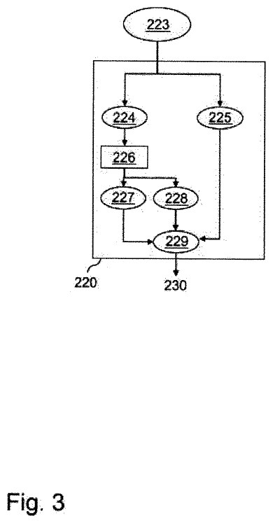

FIG. 3 shows method steps of a method according to the invention, data generation of the training data being shown,

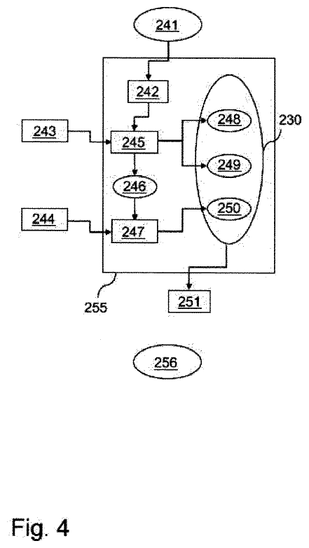

FIG. 4 shows method steps of a method according to the invention, training of an image evaluation means being shown,

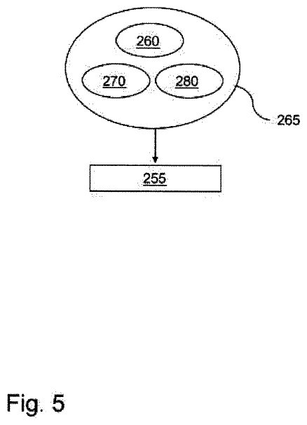

FIG. 5 shows a structure of a recording,

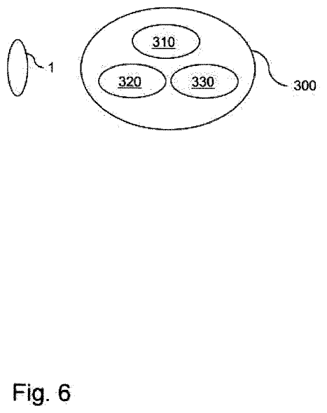

FIG. 6 shows parts of a system according to the invention.

An application of functional components 200 is visualized schematically in FIG. 1. In accordance with a method according to the invention for automatic lip reading in the case of a patient 1, firstly image information 280 about a silent mouth movement of the patient 1 can be provided. The providing is effected e.g. by an image recording device 310, which is shown in FIG. 6 as part of a system 300 according to the invention. The image recording device 310 comprises a camera, for example, which records the mouth movement of the patient 1 and stores it as the image information 280. For this purpose, the image information 280 can e.g. be transferred by means of a data transfer to a memory of the system 300 according to the invention and be buffer-stored there. Afterward, an (in particular automatic, electronic) application of an image evaluation means 210 can be effected, which involves using the image information 280 for an input 201 of the image evaluation means 210 in order to use an output 202 of the image evaluation means 210 as audio information 270. The application can comprise digital data processing, for example, which is executed by at least one electronic processor of the system 300, for example. Furthermore, the output 202 can be a digital output, for example, the content of which is regarded or used as audio information in the sense of MFCC. Subsequently, an (in particular automatic, electronic) application of a speech evaluation means 240 for speech recognition with the audio information 270 for an input of the speech evaluation means 240 can be effected in order to use an output of the speech evaluation means 240 as speech information 260 about the mouth movement. This application, too, can comprise digital data processing which is executed by at least one electronic processor of the system 300, for example. In this case, the output 202 of the image evaluation means 210 can also be used directly as input for the speech evaluation means 240, and the output of the speech evaluation means 240 can be used directly as speech information 260.

For the application in FIG. 1, a previously trained image evaluation means 210 (such as a neural network) can be used as the image evaluation means 210. In order to obtain the trained image evaluation means 210, firstly training 255 (described in even greater detail below) of an (untrained) image evaluation means 210 can be effected. For this purpose, a recording 265 shown in FIG. 5 can be used as training data 230. The recording 265 results e.g. from a video and audio recording of a mouth movement of a speaker and the associated spoken speech. In this case, the spoken speech is required only for the training and can optionally also be supplemented manually.

The training 255 of the image evaluation means 210 can be carried out in order that the image evaluation means 210 trained in this way is provided as the functional component 200, wherein image information 280 of the training data 230 is used for an input 201 of the image evaluation means 210 and audio information 270 of the training data 230 is used as a learning specification for an output 202 of the image evaluation means 210 in order to train the image evaluation means 210 to artificially generate the speech during a silent mouth movement. The image evaluation means 210 can accordingly be specifically trained and thus optimized to carry out artificial generation of the speech during a—silent—mouth movement, but not during spoken speech, and/or in a medical context. This can be effected by the selection of the training data 230, in the case of which the training data 230 comprise silent speech and/or speech with contents in a medical context. The speech contents of the training data 230 comprise in particular patient wishes and/or patient indications which often occur in the context of such a medical treatment in which the spoken speech of the patients is restricted and/or prevented.

The audio information 270 and image information 280 of the recording 265 or of the training data 230 can be assigned to one another since, if appropriate, both items of information are recorded simultaneously. By way of example, a simultaneous video and audio recording of a speaking process of the speaker 1 is carried out for this purpose. Accordingly, the image information 280 can comprise a video recording of the mouth movement during said speaking process and the audio information 270 can comprise a sound recording 265 of the speaking process during the mouth movement. Furthermore, it is conceivable for this information also to be supplemented by speech information 260 comprising the linguistic content of the speech during the speaking process. Said speech information 260 can be added e.g. manually in text form, and can thus be provided e.g. as digital data. In this way, it is possible to create different recordings 265 for different spoken words or sentences or the like. As is illustrated in FIG. 5, the recording 265 with the audio information, image information, and optionally the speech information 260, provided for the training, can form the training data 230 in the form of a common training data set 230. In contrast to the application case, in the case of training, the audio information, image information and optionally also the speech information 260 can thus be training data that are predefined and e.g. created manually specifically for the training.

Besides this manual creation, freely available data sets can also be used as recording 265 or training data 230. By way of example, reference shall be made here to the publication by “Colasito et al., Correlated lip motion and voice audio data, Journal Data in Brief, Elsevier, volume 21, pp. 856-860” and “M. Cooke, J. Barker, S. Cunningham, and X. Shao, ‘An audio-visual corpus for speech perception and automatic speech recognition’, The Journal of the Acoustical Society of America, vol. 120, No. 5, pp. 2421-2424, 2006”.

Automatic lip reading can specifically denote the visual recognition of speech by way of the lip movements of the speaker 1. In the context of the training 255, the speech can concern in particular speech that is actually uttered acoustically. In the case of the training 255, it is thus advantageous if the audio information 270 has the acoustic information about the speech which was actually uttered acoustically during the mouth movement recorded in the image information 280. In contrast thereto, the trained image evaluation means 210 can be used for lip reading even if the acoustic information about the speech is not available, e.g. during the use of sign language or during a medical treatment which does not prevent the mouth movement but prevents the acoustic utterance. In this case, the image evaluation means 210 is used to obtain the audio information 270 as an estimation of the (not actually available) speech (which is plausible for the mouth movement).

The training 255 can be based on a recording 265 of one or a plurality of speakers 1. Firstly, provision can be made for the image information 280 to be recorded as video, e.g. with grayscale images having a size of 360×288 pixels and 1 kbit/s. From this image information 280, the region of the mouth movement can subsequently be extracted and optionally normalized. The result can be represented as an array e.g. having the dimensions (F, W, H)=(75×50×100), where F denotes the number of frames, W denotes the image width and H denotes the image height.

The speech evaluation means 240 can be embodied as a conventional speech recognition program. Furthermore, the speech evaluation means 240 can be embodied as an audio model which, from the calculated MFCC, i.e. the result of the image evaluation means 210, outputs as output 202 a text or sentence related to said MFCC.

The image evaluation means 210 and/or the speech evaluation means 240 can in each case use LSTM (Long Short-Term Memory) units, as described inter alia in “J. S. Chung, A. Senior, O. Vinyals, and A. Zisserman, ‘Lip reading sentences in the wild’, in 2017 IEEE Conference on Computer Vision and Pattern Recognition (CVPR). IEEE, 2017, pp. 3444-3453”. The LSTM units can be embodied to detect the influence of inputs 201 from earlier time steps on the current predicted time step. Moreover, the use of bidirectional layers can be added in this case. That means that for the prediction of the current time step the LSTM unit has the possibility of taking account of inputs 201 which are based on previous and further time steps.

The speech evaluation means 240 can assume as input 201 the audio information 270, in particular as MFCC. It may then be necessary firstly to estimate the audio information 270 or the MFCC since the latter is available during the recording 265 for the training, but not during the application (rather only the image information 280). Various configurations of the image evaluation means 210 are appropriate for estimating the audio information 270 or MFCC. The image evaluation means 210 can accordingly be understood as an MFCC estimator. The image evaluation means 210 can furthermore have for this purpose a feature encoder and/or an artificial neural network, such as an RNN and/or CNN, in order to produce the output 202.

Furthermore, a decoder can be provided in order to perform an additional evaluation on the basis of the result from the two cascading models (i.e. from the image and speech evaluation means 240). In this case, a plausibility of the output of the speech evaluation means 240 can be checked e.g. with the aid of a dictionary. Obvious linguistic errors can furthermore be corrected. In the case of errors, an erroneous word of the speech information 260 can be replaced with a different word.

FIG. 2 illustrates an application of an image evaluation means 210 with the image information 280 for the input 201 of the image evaluation means 210. The input 201 and/or the image information 280 are/is embodied e.g. with a three-dimensional data structure. By way of example, the format (F, W, H)=(75, 50, 100), where F indicates the number of frames, W indicates the image width and H indicates the image height, can be chosen for the image information 280 or input 201. After this application has been carried out, an output 202 of the image evaluation means 210 can be used as audio information 270. The output 202 or audio information 270 can have a two-dimensional data structure, and can be present e.g. as an audio signal or MFCC. It has furthermore been found to be advantageous to use the architecture described in greater detail below. Firstly, 4 convolutional layers 211 can process the input 201 successively. Each of the convolutional layers 211 can be parameterized e.g. with a filter number F=64. In this case, F is the number of filters, which can correspond to the number of neurons in the convolutional layer 211 which link to the same region in the input. Said parameter F can furthermore determine the number of channels (feature maps) in the output of the convolutional layer 211. Consequently, F can indicate the dimensionality in the output space, i.e. the number of output filters of the convolution. Furthermore, each of the convolutional layers 211 can be parameterized with a filter size (kernel size) K=(5,3,3). In this case, K can indicate the depth, height and width of the three-dimensional convolution window. This parameter thus defines the size of the local regions to which the neurons link in the input. Furthermore, the convolutional layers 211 can be parameterized with a stride parameter (strides) S=(1,2,2). In this case, S indicates the stride for moving through the input in three dimensions. This can be indicated as a vector [a b c] with three positive integers, where a can be the vertical stride, b can be the horizontal stride and c can be the stride along the depth. A flattening layer 212 (also referred to as flattenLayer) can be provided downstream of the convolutional layers 211 in order to transfer the spatial dimensions of the output of the convolutional layers 211 into a desired channel dimension of the downstream layers. The downstream layers comprise e.g. the illustrated GRU units 213, the last output of which yields the output 202. The GRU units 213 are configured in each case as so-called gated recurrent units, and thus constitute a gating mechanism for the recurrent neural network. The GRU units 213 offer the known GRU operation in order to enable a network to learn dependencies between time steps in time series and sequence data. The image evaluation means 210 formed in this way can also be referred to as a video-following-MFCC model since the image information 280 can be used for the input 201 and the output 202 can be used as audio information 270.

The architecture illustrated in FIG. 2 can have the advantage that visual encoding takes place by way of the convolutional layers 211, thereby reducing the requirements in respect of the image information 280. If a PCA (principal component analysis) were used e.g. instead of the convolutional layers 211 directly at the input, then this would necessitate a complex adaptation of the image information 280. By way of example, the lips of the patient 1 in the image information 280 would always have to be at the same position. This can be avoided in the case of the architecture described. Furthermore, the small size of the filters of the convolutional layers 211 enables the processing complexity to be reduced. The use of a speech model can additionally be provided as well.

FIGS. 3 and 4 show a possible implementation of method steps to provide at least one functional component 200 for automatic lip reading. Specifically, for this purpose, it is possible to implement the method steps shown in FIG. 3 for creating training data 230 and the method steps shown in FIG. 4 for carrying out training 255 on the basis of the training data 230.

A data generating unit 220 (in the form of a computer program) can be provided for generating the training data 230. Firstly, in accordance with a first step 223, a data set comprising a recording 265 of a speaker 1 with audio information 270 about the speech and image information 280 about the associated mouth movement of the speaker 1 can be provided. Furthermore, the data set can comprise the associated labels, i.e. e.g. predefined speech information 260 with the content of the speech. The data set involves the used raw data of a speaker 1, wherein the labels about the speech content can optionally be added manually. Afterward, in accordance with steps 224 and 225, the image and audio information can be separated. Accordingly, the image information 280 is extracted from the recording in step 224 and the audio information 270 is extracted from the recording in step 225. In accordance with step 226, the image information 280 can optionally be preprocessed (e.g. cropping or padding). Afterward, in accordance with step 227, it is possible to crop the lips in the image information 280 and, in accordance with step 228, it is possible to identify predefined landmarks in the face in the image information 280. In step 229, the extracted frames and landmarks are produced and linked again to the raw audio stream of the audio information 270 in order to obtain the training data 230.

Afterward, the training 255 of an image evaluation means 210 can be effected on the basis of the training data 230. This learning process can be summarized as follows: firstly, the audio information 270 and image information 280 can be provided by the data generating unit 220 in step 241 and can be read out e.g. from a data memory in step 242. In this case, the image information 280 can be regarded as a sequence. In this case, in accordance with step 243, the data generating unit 220 can provide a sequence length that is taken as a basis for trimming or padding the sequence. In accordance with step 245, this processed sequence can then be divided into a first portion 248, namely training frames, and a second portion 249, namely training landmarks, of the training data 230. In accordance with step 246, the audio waveforms of the audio information 270 can be continued and, in accordance with step 247, an audio feature extraction can be implemented on the basis of predefined configurations 244. In this way, the audio features from the audio information 270 are generated as a third portion 250 of the training data 230. Finally, the model 251 is formed therefrom, and the training is thus carried out on the basis of the training data 230. By way of example, in this case, the portions 248 and 249 can be used as the input 201 of the image evaluation means 210 and the portion 250 can be used as the learning specification. Afterward, further training 256 of the speech evaluation means 240 can optionally take place, wherein for this purpose optionally the output 202 of a trained image evaluation means 210 and the speech information 260 are used as training data for the further training 256.

FIG. 6 schematically illustrates a system 300 according to the invention. The system 300 can have an image recording device 310, an output device 320 for physically outputting the speech information 260 upon the application of the speech evaluation means 240 and a processing device 330 for carrying out method steps of the method according to the invention. The system 300 can be embodied as a mobile and/or medical device for application in a hospital and/or for patients. This can also be associated with a configuration of the system 300 that is specifically adapted to this application. By way of example, the system 300 has a housing that can be disinfected. Moreover, in the case of the system 300, a redundant embodiment of the processing device 330 can be provided in order to reduce a probability of failure. If the system 300 is embodied in mobile fashion, the system 300 can have a size and/or a weight which allow(s) the system 300 to be carried by a single user without aids. Furthermore, a carrying means such as a handle and/or a means of conveyance such as rollers or wheels can be provided in the case of the system 300.

### LIST OF REFERENCE SIGNS

1 Speaker, patient
200 Functional component
201 Input
202 Output
210 Image evaluation means, first functional component
211 Convolutional layer
212 Flattening layer
213 GRU unit
220 Data generating unit
230 Training data
240 Speech evaluation means, second functional component
255 Training
256 Further training
260 Speech information
265 Recording
270 Audio information
280 Image information
300 System
310 Image recording device
320 Output device
330 Processing device
223-229 Data generating steps
241-251 Training steps

1. A method for providing at least one functional component for automatic lip reading, wherein the following steps are carried out:
providing at least one recording comprising audio information about speech of a speaker and image information about a mouth movement of the speaker,
carrying out training of an image evaluation means in order to provide the trained image evaluation means as the functional component, wherein the image information is used for an input of the image evaluation means and the audio information is used as a learning specification for an output of the image evaluation means in order to train the image evaluation means to artificially generate the speech during a silent mouth movement.

2. The method as claimed in claim 1,
wherein
the training is effected in accordance with machine learning, wherein the recording is used for providing training data for the training, and the learning specification is embodied as ground truth of the training data.

3. The method as claimed in claim 1,
wherein
the image evaluation means is embodied as a neural network.

4. The method as claimed in claim 1,
wherein
the audio information is used as the learning specification by virtue of speech features being determined from a transformation of the audio information, wherein the speech features are embodied as MFCC, such that the image evaluation means is trained for use as an MFCC estimator.

5. The method as claimed in claim 1,
wherein
the recording additionally comprises speech information about the speech, and the following step is carried out:
carrying out further training of a speech evaluation means for speech recognition, wherein the audio information and/or the output of the trained image evaluation means are/is used for an input of the speech evaluation means and the speech information is used as a learning specification for an output of the speech evaluation means.

6. A method for automatic lip reading in the case of a patient, wherein the following steps are carried out:
providing at least one item of image information about a silent mouth movement of the patient,
carrying out an application of an image evaluation means with the image information for an input of the image evaluation means in order to use an output of the image evaluation means as audio information
carrying out an application of a speech evaluation means for speech recognition with the audio information for an input of the speech evaluation means in order to use an output of the speech evaluation means as speech information about the mouth movement.

7. The method as claimed in claim 6,
wherein
the image evaluation means and the speech evaluation means are configured as, in particular different, neural networks which are applied sequentially for automatic lip reading.

8. The method as claimed in claim 1,
wherein
the speech evaluation means is configured as a speech recognition algorithm in order to generate the speech information from the audio information in the form of acoustic information artificially generated by the image evaluation means.

9. The method as claimed in claim 6,
wherein
the method is embodied as an at least two-stage method for speech recognition of silent speech that is visually perceptible on the basis of the mouth movement, wherein sequentially firstly the audio information is generated by the image evaluation means in a first stage and subsequently the speech information is generated by the speech evaluation means on the basis of the generated audio information in a second stage.

10. The method as claimed in claim 6,
wherein
the image evaluation means has at least one convolutional layer which directly processes the input of the image evaluation means.

11. The method as claimed in claim 6,
wherein
the image evaluation means has at least one GRU unit in order to directly generate the output of the image evaluation means.

12. The method as claimed in claim 6,
wherein
the image evaluation means has at least two or at least four convolutional layers.

13. The method as claimed in claim 6,
wherein
the number of successively connected convolutional layers of the image evaluation means is provided in the range of 2 to 10.

14. The method as claimed in claim 6,
wherein
the speech information is embodied as semantic information about the speech spoken silently by means of the mouth movement of the patient.

15. The method as claimed in claim 6,
wherein
in addition to the mouth movement, the image information also comprises a visual recording of the facial gestures of the patient in order that, on the basis of the facial gestures, too, the image evaluation means determines the audio information as information about the silent speech of the patient.

16. The method as claimed in claim 6,
wherein
the image evaluation means and/or the speech evaluation means are/is provided in each case as functional components by way of a method of
providing at least one recording comprising audio information about speech of a speaker and image information about a mouth movement of the speaker,
carrying out training of an image evaluation means in order to provide the trained image evaluation means as the functional component, wherein the image information is used for an input of the image evaluation means and the audio information is used as a learning specification for an output of the image evaluation means in order to train the image evaluation means to artificially generate the speech during a silent mouth movement.

17. A system for automatic lip reading in the case of a patient, having:
an image recording device for providing image information about a silent mouth movement of the patient,
a processing device for carrying out at least the steps of an application of an image evaluation means and of a speech evaluation means of a method as claimed in claim 6.

18. The system as claimed in claim 17,
wherein
provision is made of an output device for acoustically and/or visually outputting the speech information.

19. A computer program, comprising instructions which, when the computer program is executed by a processing device, cause the latter to carry out at least the steps of an application of an image evaluation means and of a speech evaluation means of a method as claimed in claim 6.
